(19) United States
(12) Patent Application Publication
(10) Pub. No.: US 2012/0113221 A1
(43) Pub. Date: May 10, 2012

(54) IMAGE PROCESSING APPARATUS AND METHOD

(75) Inventors: Kunio YAMADA, Yokohama-shi (JP); Yasunari SUZUKI, Yokosuka-shi (JP)

(73) Assignee: JVC KENWOOD CORPORATION, Kanagawa (JP)

(21) Appl. No.: 13/285,129

(22) Filed: Oct. 31, 2011

(30) Foreign Application Priority Data
Nov. 4, 2010 (JP) 2010-247031

(51) Int. Cl. H04N 13/00

(52) U.S. Cl. 348/43; 348/E13.001

(57) ABSTRACT

A combination image has a pair of 3D-presentation images horizontally or vertically arranged and resulting from compressing original 3D-presentation images into half size. One of the left-hand and right-hand haves or the upper and lower halves of the combination image is set as a to-be-enhanced image while the other is set as a reference image. A block having a prescribed number of pixels is formed in the to-be-enhanced image. The formed block extends at and around an interpolation object position. The reference image is searched for a reference block matching in pattern with the formed block. A value at a pixel in the reference block which positionally corresponds to the interpolation object position is decided to be a candidate value for an interpolation-result pixel. The interpolation-result pixel having the candidate value is placed at the interpolation object position to change the to-be-enhanced image into a resolution-enhanced image.

### BACKGROUND OF THE INVENTION

1. Field of the Invention

This invention generally relates to image processing apparatus and method. This invention particularly relates to a method and an apparatus for processing signals representing images which may conform to the stereoscopic or 3D (three-dimensional) video standards.

2. Description of the Related Art

Systems for transmitting and recording signals representing stereoscopic images include a side-by-side 3D system (an SBS 3D system) and an above-below (AB) 3D system.

Each of the SBS 3D system and the AB 3D system compresses 1-frame images in every 3D-presentation pair along the horizontal direction or the vertical direction, and transmits the compression-result images as a 1-frame image. The SBS 3D system and the AB 3D system have the features that SBS 3D video and AB 3D video can be transmitted by use of conventional transmission systems, and the consideration of the synchronization between the left-eye channel and the right-eye channel is unnecessary.

There are various techniques of generating high-resolution images from low-resolution images. In particular, investigations have been given of techniques of generating a high-resolution image by combining low-resolution images having positional errors over a plurality of frames.

Techniques of generating high-resolution images from low-resolution images are disclosed in, for example, Japanese patent application publication numbers 2004-056789, 2007-000205, 2007-257042, and 2008-017241.

The number of horizontally aligned pixels or vertically aligned pixels in every compression-result image generated by the SBS 3D system or the AB 3D system is equal to half of that of the original 1-frame image. Thus, the horizontal-direction or vertical-direction resolution of every 1-frame image resulting from expanding a compression-result image on a bilinear or bicubic interpolation basis is significantly lower than that of the original 1-frame image.

Each of the techniques in Japanese applications 2004-056789, 2007-000205, 2007-257042, and 2008-017241 uses interframe integration for enhancing the image quality and the image processing efficiency to acquire a high-resolution image. In the absence of corresponding portions in successive frames, the image quality can not be enhanced by interframe integration. In the case where detailed motion estimation is precisely carried out for each of newly added sample points over a wide area during interframe integration, search requires a very high calculation cost.

### SUMMARY OF THE INVENTION

It is a first object of this invention to provide a method of processing a 3D-presentation pair of compression-result images into a 3D-presentation pair of original-size images through a technology simpler than conventional interframe integration.

It is a second object of this invention to provide an apparatus for processing a 3D-presentation pair of compression-result images into a 3D-presentation pair of original-size images through a technology simpler than conventional interframe integration.

A first aspect of this invention provides a method of processing a signal representative of a combination image having a pair of 3D-presentation images horizontally arranged and resulting from compressing original 3D-presentation images into half size. The method comprises the steps of setting one of the left-hand and right-hand haves of the combination image as a to-be-enhanced image and setting the other as a reference image; forming a block in the to-be-enhanced image, the block having a prescribed number of pixels and extending at and around an interpolation object position in the to-be-enhanced image; searching the reference image for a reference block matching in pattern with the formed block; deciding a value at a pixel in the reference block which positionally corresponds to the interpolation object position in the to-be-enhanced image to be a candidate value for an interpolation-result pixel; and placing the interpolation-result pixel having the candidate value at the interpolation object position in the to-be-enhanced image to change the to-be-enhanced image into a resolution-enhanced image.

A second aspect of this invention is based on the first aspect thereof, and provides a method wherein the searching step comprises setting a center between two horizontally neighboring pixels in the formed block as the interpolation object position; generating a search base pixel having a value equal to an average of values of the two horizontally neighboring pixels; placing the search base pixel between the two horizontally neighboring pixels to generate a new block from the formed block; and using the new block as the formed block in the searching.

A third aspect of this invention provides a method of processing a signal representative of a combination image having a pair of 3D-presentation images vertically arranged and resulting from compressing original 3D-presentation images into half size. The method comprises the steps of setting one of the upper and lower haves of the combination image as a to-be-enhanced image and setting the other as a reference image; forming a block in the to-be-enhanced image, the block having a prescribed number of pixels and extending at and around an interpolation object position in the to-be-enhanced image; searching the reference image for a reference block matching in pattern with the formed block; deciding a value at a pixel in the reference block which positionally corresponds to the interpolation object position in the to-be-enhanced image to be a candidate value for an interpolation-result pixel; and placing the interpolation-result pixel having the candidate value at the interpolation object position in the to-be-enhanced image to change the to-be-enhanced image into a resolution-enhanced image.

A fourth aspect of this invention is based on the third aspect thereof, and provides a method wherein the searching step comprises setting a center between two vertically neighboring pixels in the formed block as the interpolation object position; generating a search base pixel having a value equal to an average of values of the two vertically neighboring pixels; placing the search base pixel between the two vertically neighboring pixels to generate a new block from the formed block; and using the new block as the formed block in the searching.

A fifth aspect of this invention provides an apparatus for processing a signal representative of a combination image having a pair of 3D-presentation images horizontally arranged and resulting from compressing original 3D-presentation images into half size. The apparatus comprises a searcher setting one of the left-hand and right-hand haves of the combination image as a to-be-enhanced image and setting the other as a reference image, the searcher forming a block in the to-be-enhanced image, the block having a prescribed number of pixels and extending at and around an interpolation object position in the to-be-enhanced image, the searcher searching the reference image for a reference block matching in pattern with the formed block; a candidate value decider deciding a value at a pixel in the reference block which positionally corresponds to the interpolation object position in the to-be-enhanced image to be a candidate value for an interpolation-result pixel; and an interpolation processor placing the interpolation-result pixel having the candidate value at the interpolation object position in the to-be-enhanced image to change the to-be-enhanced image into a resolution-enhanced image.

A sixth aspect of this invention is based on the fifth aspect thereof, and provides an apparatus wherein the searcher sets a center between two horizontally neighboring pixels in the formed block as the interpolation object position, and generates a search base pixel having a value equal to an average of values of the two horizontally neighboring pixels, and wherein the searcher places the search base pixel between the two horizontally neighboring pixels to generate a new block from the formed block, and uses the new block as the formed block in the searching.

A seventh aspect of this invention provides an apparatus for processing a signal representative of a combination image having a pair of 3D-presentation images vertically arranged and resulting from compressing original 3D-presentation images into half size. The apparatus comprises a searcher setting one of the upper and lower haves of the combination image as a to-be-enhanced image and setting the other as a reference image, the searcher forming a block in the to-be-enhanced image, the block having a prescribed number of pixels and extending at and around an interpolation object position in the to-be-enhanced image, the searcher searching the reference image for a reference block matching in pattern with the formed block; a candidate value decider deciding a value at a pixel in the reference block which positionally corresponds to the interpolation object position in the to-be-enhanced image to be a candidate value for an interpolation-result pixel; an interpolation processor placing the interpolation-result pixel having the candidate value at the interpolation object position in the to-be-enhanced image to change the to-be-enhanced image into a resolution-enhanced image.

An eighth aspect of this invention is based on the seventh aspect thereof, and provides an apparatus wherein the searcher sets a center between two vertically neighboring pixels in the formed block as the interpolation object position, and generates a search base pixel having a value equal to an average of values of the two vertically neighboring pixels, and wherein the searcher places the search base pixel between the two vertically neighboring pixels to generate a new block from the formed block, and uses the new block as the formed block in the searching.

This invention has the following advantage. This invention processes every pair of half-size images which result from compressing full-size images for 3D presentation. Specifically, the processing by this invention implements interpolation to expand half-size images in every 3D-presentation pair into full-size images relatively high in quality. The interpolation uses a correlation between half-size images in every 3D-presentation pair. Therefore, the processing by this invention is simpler than conventional image processing based on interframe integration.

### BRIEF DESCRIPTION OF THE DRAWINGS

FIG. 1 is a block diagram of an image processing apparatus according to a first embodiment of this invention.

FIG. 2 is a flowchart of a control program for a computer which may be provided in the image processing apparatus of the first embodiment of this invention.

FIG. 3 is a diagram showing an example of a 3D-presentation pair of a 1-frame image for viewer's left eye and a 1-frame image for viewer's right eye.

FIG. 4 is a diagram showing a 1-frame SBS image consisting of a half-size left-eye image and a half-size right-eye image arranged side by side and resulting from compressing the 1-frame left-eye image and the 1-frame right-eye image in FIG. 3 respectively.

FIG. 5 is a diagram showing two horizontally-neighboring actual pixels between which a middle pixel is placed by interpolation.

FIG. 6 is a diagram of a basic block having a prescribed number of actual pixels.

FIG. 7 is a diagram showing the basic block and a new block generated based on the basic block in FIG. 6 and having a prescribed number of middle pixels, and used in vector search implemented by the image processing apparatus of the first embodiment of this invention.

FIG. 8 is a block diagram of an image processing apparatus according to a second embodiment of this invention.

FIG. 9 is a flowchart of a control program for a computer which may be provided in the image processing apparatus of the second embodiment of this invention.

FIG. 10 is a diagram showing a 1-frame AB image consisting of a half-size left-eye image and a half-size right-eye image vertically arranged and resulting from compressing the 1-frame left-eye image and the 1-frame right-eye image in FIG. 3 respectively.

FIG. 11 is a diagram showing two vertically-neighboring actual pixels between which a middle pixel is placed by interpolation.

FIG. 12 is a diagram showing a basic block having a prescribed number of actual pixels, and a new block which is generated based on the basic block and has a prescribed number of middle pixels, and which is used in vector search implemented by the image processing apparatus of the second embodiment of this invention.

FIG. 13 is a block diagram of the computer in the image processing apparatus of the first embodiment of this invention.

FIG. 14 is a block diagram of the computer in the image processing apparatus of the second embodiment of this invention.

### DETAILED DESCRIPTION OF THE INVENTION

### First Embodiment

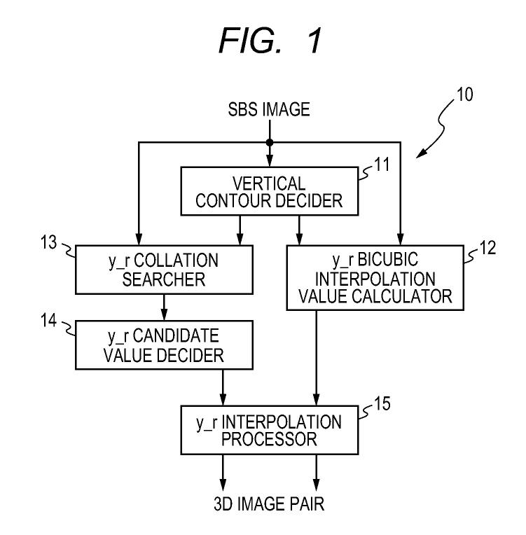

FIG. 1 shows an image processing apparatus 10 according to a first embodiment of this invention. As shown in FIG. 1, the apparatus 10 includes a vertical contour decider 11, a y_r bicubic interpolation value calculator 12, a y_r collation searcher 13, a y_r candidate value decider 14, and a y_r interpolation processor 15.

The apparatus 10 receives an input video signal representing a stream of pairs of low-resolution small-size images which result from compressing high-resolution full-size images for 3D presentation through the use of an SBS 3D system. Every pair of low-resolution small-size images is referred to as an SBS image also. The apparatus 10 expansively processes SBS images into full-size images making pairs for 3D presentation.

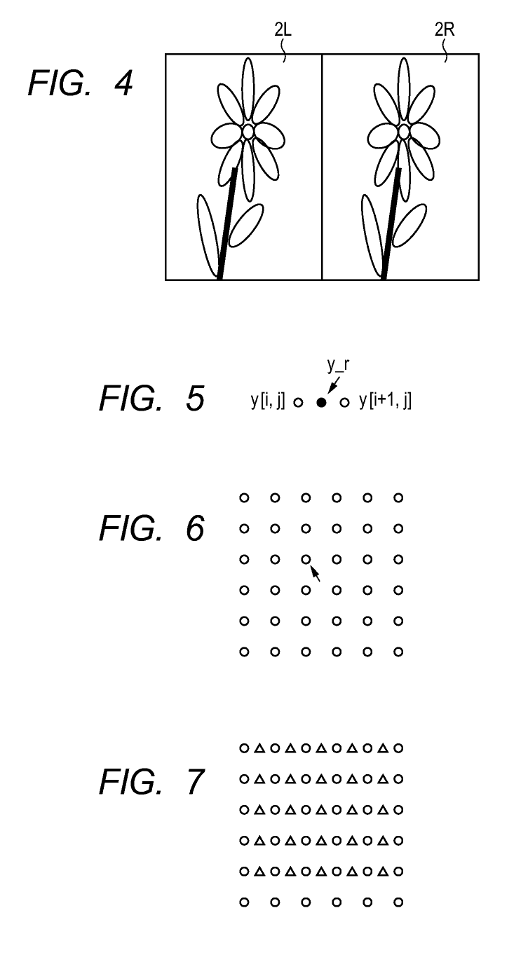

FIG. 3 shows an example of a 3D-presentation pair of a 1-frame image 1L for viewer's left eye and a 1-frame image 1R for viewer's right eye. The SBS 3D system compresses the 1-frame left-eye image 1L in the horizontal direction to generate a half-size left-eye image 2L shown in FIG. 4. In addition, the SBS 3D system compresses the 1-frame right-eye image 1R in the horizontal direction to generate a half-size right-eye image 2R shown in FIG. 4. Then, the SBS 3D system places the half-size left-eye image 2L and the half-size right-eye image 2R side by side to form a 1-frame SBS image to be transmitted.

With reference to FIG. 5, “y_r” denotes a middle pixel at a sample point intermediate between an actual pixel y[i, j] and an actual pixel y[i+1, j] neighboring along the horizontal direction in each of left-hand and right-hand halves of every 1-frame SBS image.

The apparatus 10 implements image processing for deciding middle pixels from every 1-frame SBS image represented by the input video signal. The implemented image processing is on luminance. The implemented image processing may be on color difference or primary color system in addition to luminance.

As shown in FIG. 4, the left-hand half of every 1-frame SBS image is occupied by a half-size left-eye image 2L while the right-hand half thereof is occupied by a half-size right-eye image 2R. Thus, the left-hand half of every 1-frame SBS image corresponds to the left-eye channel while the right-hand half thereof corresponds to the right-eye channel.

When the left-eye channel half of a 1-frame SBS image is subjected to resolution enhancement by adding middle pixels through interpolation, the apparatus 10 uses the right-eye channel half of the 1-frame SBS image as a reference image for resolution enhancement. On the other hand, when the right-eye channel half of a 1-frame SBS image is subjected to resolution enhancement, the apparatus 10 uses the left-eye channel half of the 1-frame SBS image as a reference image for resolution enhancement.

The apparatus 10 sequentially processes pixels of every 1-frame SBS image in the order same as the conventional raster scanning order. The apparatus 10 implements interpolation alternately for left-hand halves and right-hand halves of 1-frame SBS images in a manner such that when one of the left-hand and right-hand halves of a current 1-frame SBS image is to be enhanced in resolution through interpolation, the other is used as a reference image. The left-hand or right-hand half of a 1-frame SBS image which is to be enhanced in resolution is referred to as the to-be-enhanced image also. Thus, for example, during the former half of one cycle for a 1-frame SBS image, the left-hand and right-hand halves of the 1-frame SBS image are handled as a to-be-enhanced image and a reference image respectively. During the later half of one cycle, the left-hand and right-hand halves of the 1-frame SBS image are handled as a reference image and a to-be-enhanced image respectively.

The vertical contour decider 11 decides whether or not a vertical contour is present in each of portions of the to-be-enhanced image in every 1-frame SBS image represented by the input video signal. Specifically, the vertical contour decider 11 calculates the difference (the absolute-value difference) between values at two pixels neighboring in the horizontal direction, and compares the calculated difference with a prescribed value. When the calculated difference is greater than the prescribed value, the vertical contour decider 11 decides that a vertical contour is present in a corresponding portion of the to-be-enhanced image. Otherwise, the vertical contour decider 11 decides that a vertical contour is absent. The vertical contour decider 11 notifies the result of the decision to the y_r bicubic interpolation value calculator 12 and the y_r collation searcher 13.

The y_r bicubic interpolation value calculator 12 implements known bicubic interpolation with respect to the to-be-enhanced image to generate values for selected ones of the middle pixels. The y_r bicubic interpolation value calculator 12 notifies the generated values for the middle pixels to the y_r interpolation processor 15. The operation of the y_r bicubic interpolation value calculator 12 responds to the result of the decision by the vertical contour decider 11.

The y_r collation searcher 13 defines, in the to-be-enhanced image, equal-size blocks each centered at a middle pixel of interest (a middle pixel y_r whose value is to be decided through interpolation) and each having a predetermined number of middle pixels. For each of the blocks in the to-be-enhanced image, the y_r collation searcher 13 implements pattern matching between the to-be-enhanced image and the reference image to search the reference image for a hit 1-block area (called a hit reference block) equal in pattern to the present block. The y_r collation searcher 13 notifies the hit reference blocks to the y_r candidate value decider 14. The operation of the y_r collation searcher 13 responds to the result of the decision by the vertical contour decider 11.

The y_r candidate value decider 14 labels the value at the pixel in each hit reference block which positionally corresponds to the middle pixel y_r of interest in the related block of the to-be-enhanced image as a candidate value for the middle pixel y_r of interest. The y_r candidate value decider 14 notifies the candidate values for selected ones of the middle pixels to the y_r interpolation processor 15.

The y_r interpolation processor 15 expands the to-be-enhanced image into a 1-frame image in response to the middle-pixel values generated by the y_r bicubic interpolation value calculator 12 and the middle-pixel values generated by the y_r candidate value decider 14. Thereby, the y_r interpolation processor 15 generates every pair of a 1-frame left-eye image and a 1-frame right-eye image for 3D presentation as a result of decoding every 1-frame SBS image represented by the input video signal. The y_r interpolation processor 15 synchronously outputs a video signal representative of the generated 1-frame left-eye image and a video signal representative of the generated 1-frame right-eye image.

Detailed operation of the apparatus 10 is as follows. The vertical contour decider 11 decides whether or not a clear vertical contour is present in each of portions of the to-be-enhanced image in every 1-frame SBS image represented by the input video signal. As will be made clear later, each of these portions is a middle pixel y_r of interest between an actual pixel y[i, j] and an actual pixel y[i+1, j]. Specifically, the vertical contour decider 11 evaluates the to-be-enhanced image, and decides a threshold value based on the result of the evaluation. The vertical contour decider 11 calculates the absolute value of the difference between values at an actual pixel y[i+1, j] and an actual pixel y[i, j] neighboring in the horizontal direction. The vertical contour decider 11 compares the calculated absolute value with the threshold value to determine whether or not the calculated absolute value exceeds the threshold value. When the calculated absolute value exceeds the threshold value, the vertical contour decider 11 decides that a clear vertical contour is present in a corresponding portion of the to-be-enhanced image (at the middle pixel y_r of interest). Otherwise, the vertical contour decider 11 decides that a clear vertical contour is absent. The vertical contour decider 11 notifies the result of this decision to the y_r bicubic interpolation value calculator 12 and the y_r collation searcher 13.

When the vertical contour decider 11 decides that a clear vertical contour is present at the middle pixel y_r of interest, the y_r bicubic interpolation value calculator 12 implements known bicubic interpolation with respect to the to-be-enhanced image to calculate a value for the middle pixel y_r of interest. The y_r bicubic interpolation value calculator 12 notifies the calculated value for the middle pixel y_r of interest to the y_r interpolation processor 15.

When the vertical contour decider 11 decides that a clear vertical contour is absent from the middle pixel y_r of interest, the y_r collation searcher 13 implements pattern matching as follows. The y_r collation searcher 13 defines, in the to-be-enhanced image, a block approximately centered at the middle pixel y_r of interest and having 6 actual pixels in the vertical direction and 6 actual pixels in the horizontal direction as shown in FIG. 6 where the small circle denoted by the arrow indicates the actual pixel y[i, j]. For the defined block in the to-be-enhanced image, the y_r collation searcher 13 implements pattern matching between the to-be-enhanced image and the reference image to search the reference image for a hit 1-block area (a hit reference block) equal in pattern to or matching in pattern with the defined block.

In more detail, for the block in the to-be-enhanced image, the y_r collation searcher 13 places 25 middle pixels (which are denoted by the small triangles in FIG. 7) between the 30 actual pixels denoted by the small circles in FIG. 7. Each of the 25 middle pixels is located at the center between two neighboring actual pixels arranged in a horizontal direction. The y_r collation searcher 13 sets the value of each middle pixel to the average of the values of left-hand and right-hand actual pixels neighboring the middle pixel. The y_r collation searcher 13 defines a new block centered at the middle pixel y_r of interest and having 5 middle pixels in the vertical direction and 5 middle pixels in the horizontal direction. The y_r collation searcher 13 searches the reference image for a hit 1-block area (a hit reference block) equal in pattern to or matching in pattern with the new block at a 1-pixel pitch. This search detects a positional difference corresponding to a non-integral number (integer+0.5) of pixels in the horizontal direction and an integral number of pixels in the vertical direction.

The search by the y_r collation searcher 13 is to find a vector corresponding to best match. The values of 25 middle pixels for a new block are denoted by yh[i+s, j+t] where “s” indicates an integer varying from −2 to +2 and also “t” denotes an integer varying from −2 to +2. The value of a middle pixel centered at the new block is thus denoted by yh[i, j]. The values of the pixels in the reference image are denoted by g[i+s+p, j+t+q] where “p” indicates a variable in the range depending on the number of horizontally aligned pixels in the reference image, and “q” indicates a variable in the range depending on the number of vertically aligned pixels in the reference image. The pixel position coordinates for the reference image are regarded as being identical or exactly aligned with those for the to-be-enhanced image. Finding a vector corresponding to best match means finding a vector [p, q] which minimizes the following summation S.

$$S = {\sum }_{s = - 2}^{2} {\sum }_{t = - 2}^{2} abs ( yh [ i + s , j + t ] - g [ i + s + p , j + t + q ] ) \qquad ( 1 )$$

where “abs” denotes an operator for taking an absolute value. The pixel having the value g[i, j] corresponds to the pixel y[i+(w/2), j] when the to-be-enhanced image is the left-eye channel half of the 1-frame SBS image and the reference image is the right-eye channel half thereof. The pixel having the value g[i, j] corresponds to the pixel y[i−(w/2), j] when the to-be-enhanced image is the right-eye channel half of the 1-frame SBS image and the reference image is the left-eye channel half thereof. Here, “w” denotes the interval between the horizontally aligned pixels. The hit 1-block area (hit reference block) in the reference image is designated by the found vector [p, q]. The y_r collation searcher 13 notifies the hit reference block (the found vector [p, q]) to the y_r candidate value decider 14.

The horizontal-direction range of the search by the y_r collation searcher 13 is predetermined in accordance with the range of parallax in 1-frame SBS images. The vertical-direction range of the search by the y_r collation searcher 13 is predetermined in accordance with the range of a positional error caused in taking pictures and caused by other factors. The parallax range and the positional error range can be decided by monitoring actual images.

The y_r candidate value decider 14 uses the value at the pixel in each hit reference block which positionally corresponds to the middle pixel y_r of interest in the related block of the to-be-enhanced image as a candidate value for the middle pixel y_r of interest. The y_r candidate value decider 14 notifies the candidate value for the middle pixel y_r of interest to the y_r interpolation processor 15.

The y_r interpolation processor 15 labels the middle-pixel value generated by the y_r bicubic interpolation value calculator 12 or the middle-pixel value generated by the y_r candidate value decider 14 as a final value assigned to the middle pixel y_r of interest. The y_r interpolation processor 15 implements interpolation to place the middle pixel y_r of interest, which has been assigned the final value, equidistantly between the actual pixel y[i, j] and the actual pixel y[i+1, j] in the to-be-enhanced image as an interpolation-result pixel.

The to-be-enhanced image is scanned while the middle pixel y_r of interest is periodically replaced from one to another to complete all the middle pixels (interpolation-result pixels) added to the to-be-enhanced image. Thus, the y_r interpolation processor 15 expands the to-be-enhanced image into a 1-frame image in response to the middle-pixel values generated by the y_r bicubic interpolation value calculator 12 and the middle-pixel values generated by the y_r candidate value decider 14. Specifically, the y_r interpolation processor 15 labels the middle-pixel values generated by the y_r bicubic interpolation value calculator 12 and the middle-pixel values generated by the y_r candidate as final values assigned to the middle pixels. The y_r interpolation processor 15 implements interpolation to place the middle pixels, which have been assigned the final values, horizontally between the actual pixels in the to-be-enhanced image to generate an expanded 1-frame image. Thereby, the y_r interpolation processor 15 generates every pair of a 1-frame left-eye image and a 1-frame right-eye image for 3D presentation as a result of decoding every 1-frame SBS image represented by the input video signal. The generated 1-frame left-eye image is higher in definition (resolution) than the left-eye channel half of the 1-frame SBS image. The generated 1-frame right-eye image is higher in definition (resolution) than the right-eye channel half of the 1-frame SBS image. The y_r interpolation processor 15 synchronously outputs a video signal representative of the generated 1-frame left-eye image and a video signal representative of the generated 1-frame right-eye image.

The half-size left-eye image 2L and the half-size right-eye image 2R in FIG. 4 which constitute the 1-frame SBS image are in a pair for 3D presentation so that they closely resemble each other in contents. Thus, in many cases, good correspondence or correlation between the to-be-enhanced image and the reference image is ensured. Furthermore, the range of the search for a hit reference block in the reference image can be relatively narrow. Accordingly, the apparatus 10 can solve the problems caused by interframe integration for acquiring a high-resolution image. The apparatus 10 can generate every 3D-presentation pair of a decoding-result 1-frame left-eye image and a decoding-result 1-frame right-eye image which are close in quality and resolution to the original 1-frame left-eye image and the original 1-frame right-eye image. In the apparatus 10, actual pixels in a reference image can be used for interpolation to expand a to-be-enhanced image into a 1-frame image. Thus, image sharpness can be prevented from being dropped by band limitation caused in the case of conventional pixel linear interpolation.

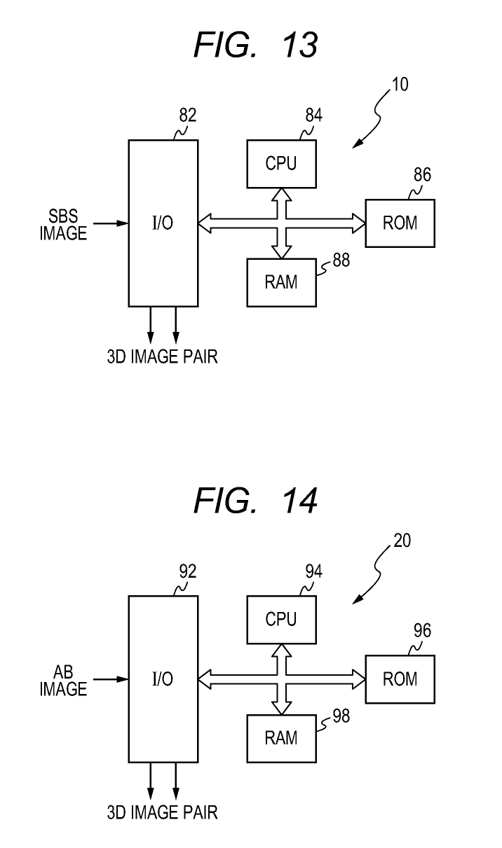

With reference to FIG. 13, the apparatus 10 may include a computer having a combination of an input/output port 82, a CPU 84, a ROM 86, and a RAM 88. In this case, the apparatus 10 or the computer operates in accordance with a control program (computer program) stored in the ROM 86 or the RAM 88. The control program is designed to implement the vertical contour decider 11, the y_r bicubic interpolation value calculator 12, the y_r collation searcher 13, the y_r candidate value decider 14, and the y_r interpolation processor 15. The input/output port 82 receives the input video signal. The input/output port 82 synchronously outputs a video signal representative of a stream of decoding-result 1-frame left-eye images and a video signal representative of a stream of decoding-result 1-frame right-eye images.

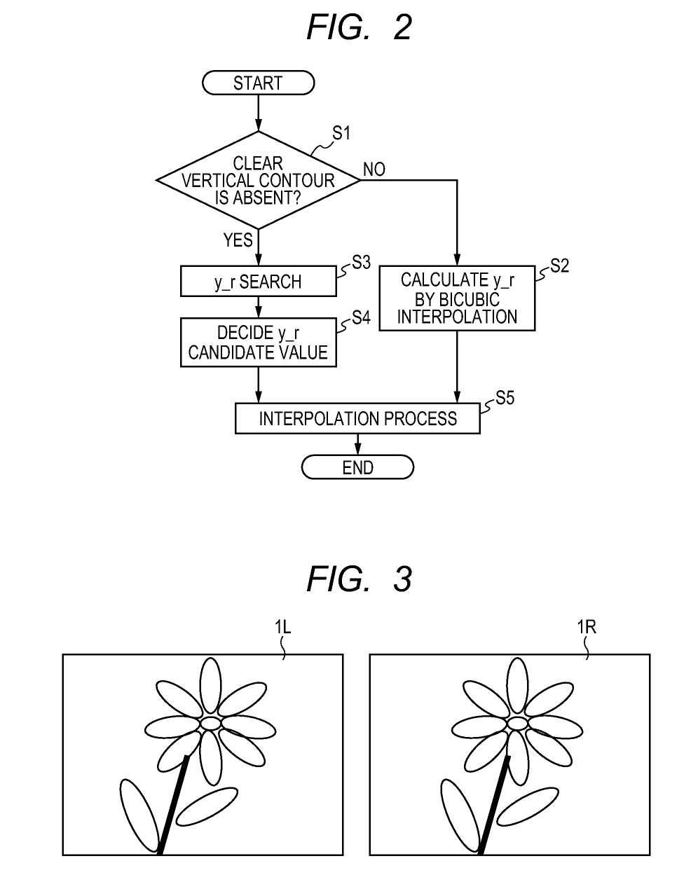

FIG. 2 is a flowchart of a segment of the control program which is executed for each of the middle pixels in the to-be-enhanced image being either the left-hand or right-hand half of every 1-frame SBS image represented by the input video signal.

As shown in FIG. 2, a first step S1 of the program segment decides whether or not a clear vertical contour is present at a middle pixel y_r of interest horizontally between an actual pixel y[i, j] and an actual pixel y[i+1, j] in the to-be-enhanced image. Specifically, the step S1 calculates the absolute value of the difference between values at the pixel y[i+1, j] and the pixel y[i, j]. The step S1 compares the calculated absolute value with a predetermined threshold value to determine whether or not the calculated absolute value exceeds the threshold value. When the calculated absolute value exceeds the threshold value, the step S1 decides that a clear vertical contour is present at the middle pixel y_r of interest. In this case, the program advances from the step S1 to a step S2. When the calculated absolute value does not exceed the threshold value, the step S1 decides that a clear vertical contour is absent. In this case, the program advances from the step S1 to a step S3. The step S1 corresponds to the vertical contour decider 11.

The step S2 implements known bicubic interpolation with respect to the to-be-enhanced image to calculate a value for the middle pixel y_r of interest. After the step S2, the program advances to a step S5. The step S2 corresponds to the y_r bicubic interpolation value calculator 12.

The step S3 searches the reference image for a hit 1-block area (a hit reference block) equal in pattern to or matching in pattern with a block in the to-be-enhanced image which is centered at the middle pixel y_r of interest. The block has a prescribed number of neighboring middle pixels. After the step S3, the program advances to a step S4. The step S3 corresponds to the y_r collation searcher 13.

The step S4 uses the value at the pixel in the hit reference block which positionally corresponds to the middle pixel y_r of interest in the related block of the to-be-enhanced image as a candidate value for the middle pixel y_r of interest. After the step S4, the program advances to the step S5. The step S4 corresponds to the y_r candidate value decider 14.

The step S5 uses the middle-pixel value generated by the step S2 or the middle-pixel value generated by the step S4 as a final value assigned to the middle pixel y_r of interest. The step S5 implements interpolation to place the middle pixel y_r of interest, which has been assigned the final value, equidistantly between the actual pixel y[i, j] and the actual pixel [i+1, j] in the to-be-enhanced image as an interpolation-result pixel. After the step S5, the current execution cycle of the program segment ends. The step S5 corresponds to the y_r interpolation processor 15.

The control program may be read from a recording medium before being loaded into the computer in the apparatus 10. Alternatively, the control program may be downloaded into the computer in the apparatus 10 from a communication network through the use of a communication interface.

### Second Embodiment

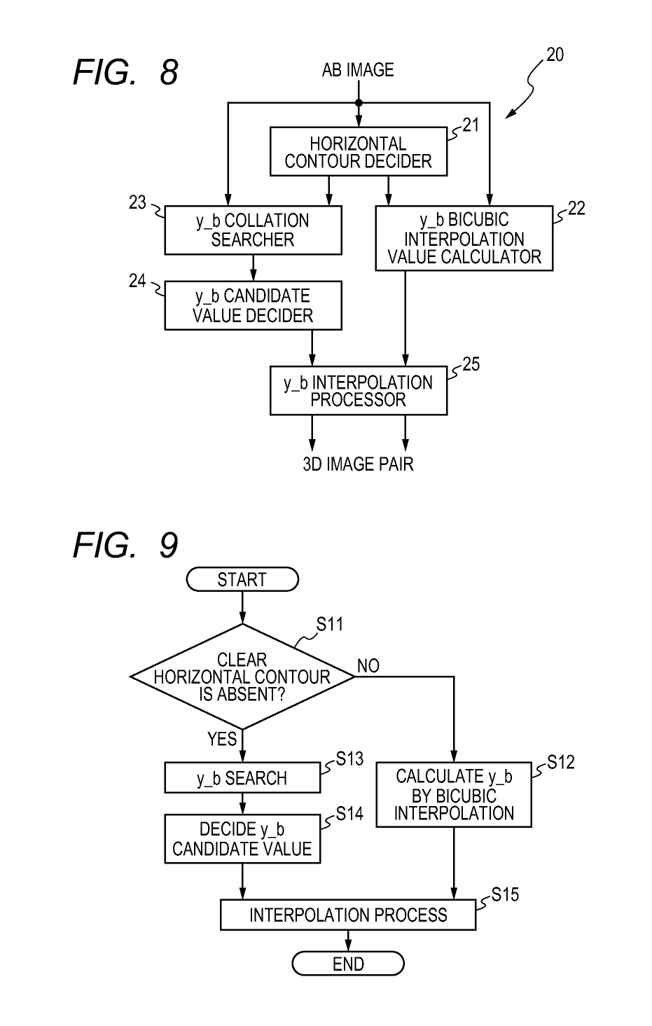

FIG. 8 shows an image processing apparatus 20 according to a second embodiment of this invention. As shown in FIG. 8, the apparatus 20 includes a horizontal contour decider 21, a y_b bicubic interpolation value calculator 22, a y_b collation searcher 23, a y_b candidate value decider 24, and a y_b interpolation processor 25.

The apparatus 20 receives an input video signal representing a stream of pairs of low-resolution small-size images which result from compressing high-resolution full-size images for 3D presentation through the use of an AB 3D system. Every pair of low-resolution small-size images is referred to as an AB image also. The apparatus 20 expansively processes AB images into full-size images making pairs for 3D presentation.

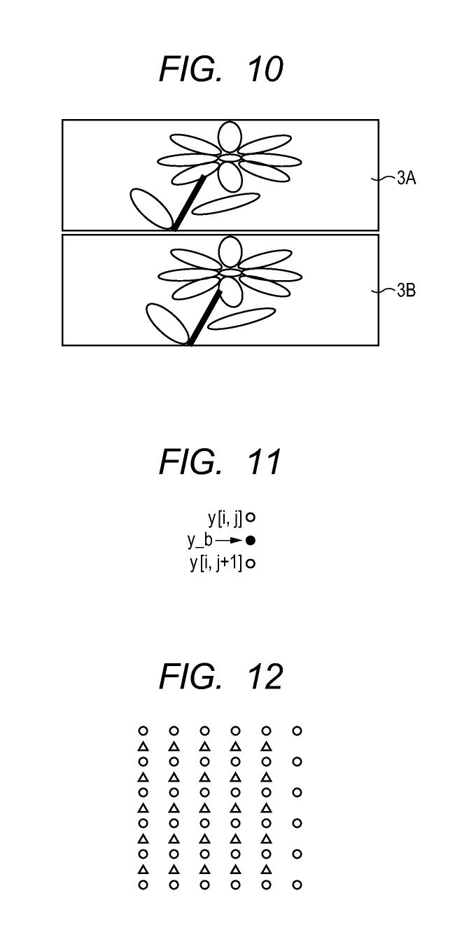

The AB 3D system compresses the 1-frame left-eye image 1L of FIG. 3 in the vertical direction to generate a half-size left-eye image 3A shown in FIG. 10. In addition, the AB 3D system compresses the 1-frame right-eye image 1R of FIG. 3 in the vertical direction to generate a half-size right-eye image 3B shown in FIG. 10. Then, the AB 3D system arranges the half-size left-eye image 3A and the half-size right-eye image 3B vertically to form a 1-frame AB image to be transmitted.

With reference to FIG. 11, “y_b” denotes a middle pixel at a sample point intermediate between an actual pixel y[i, j] and an actual pixel y[i, j+1] neighboring in the vertical direction in each of upper and lower halves of every 1-frame AB image.

The apparatus 20 implements image processing for deciding middle pixels y_b from every 1-frame AB image represented by the input video signal. The implemented image processing is on luminance. The implemented image processing may be on color difference or primary color system in addition to luminance.

As shown in FIG. 10, the upper half of every 1-frame AB image is occupied by a half-size left-eye image 3A while the lower half thereof is occupied by a half-size right-eye image 3B. Thus, the upper half of every 1-frame AB image corresponds to the left-eye channel while the lower half thereof corresponds to the right-eye channel.

When the left-eye channel half of a 1-frame AB image is subjected to resolution enhancement by adding pixels through interpolation, the apparatus 20 uses the right-eye channel half of the 1-frame AB image as a reference image for resolution enhancement. On the other hand, when the right-eye channel half of a 1-frame AB image is subjected to resolution enhancement, the apparatus 20 uses the left-eye channel half of the 1-frame AB image as a reference image for resolution enhancement.

The apparatus 20 sequentially processes pixels of every 1-frame AB image in the order same as the conventional raster scanning order. The apparatus 20 implements interpolation alternately for upper halves and lower halves of 1-frame AB images in a manner such that when one of the upper and lower halves of a current 1-frame AB image is enhanced in resolution through interpolation, the other is used as a reference image. The upper or lower half of a 1-frame AB image which is to be enhanced in resolution is referred to as the to-be-enhanced image also. Thus, for example, during the former half of one cycle for a 1-frame AB image, the upper and lower halves of the 1-frame AB image are handled as a to-be-enhanced image and a reference image respectively. During the later half of one cycle, the upper and lower halves of the 1-frame AB image are handled as a reference image and a to-be-enhanced image respectively.

The horizontal contour decider 21 decides whether or not a horizontal contour is present in each of portions of the to-be-enhanced image in every 1-frame AB image represented by the input video signal. Specifically, the horizontal contour decider 21 calculates the difference (the absolute-value difference) between values at two pixels neighboring in the vertical direction, and compares the calculated difference with a prescribed value. When the calculated difference is greater than the prescribed value, the horizontal contour decider 21 decides that a horizontal contour is present in a corresponding portion of the to-be-enhanced image. Otherwise, the horizontal contour decider 21 decides that a horizontal contour is absent. The horizontal contour decider 21 notifies the result of the decision to the y_b bicubic interpolation value calculator 22 and the y_b collation searcher 23.

The y_b bicubic interpolation value calculator 22 implements known bicubic interpolation with respect to the to-be-enhanced image to generate values for selected ones of the middle pixels. The y_b bicubic interpolation value calculator 22 notifies the generated values for the middle pixels to the y_b interpolation processor 25. The operation of the y_b bicubic interpolation value calculator 22 responds to the result of the decision by the horizontal contour decider 21.

The y_b collation searcher 23 defines, in the to-be-enhanced image, equal-size blocks each centered at a middle pixel of interest (a middle pixel y_b whose value is to be decided through interpolation) and each having a predetermined number of middle pixels. For each of the blocks in the to-be-enhanced image, the y_b collation searcher 23 implements pattern matching between the to-be-enhanced image and the reference image to search the reference image for a hit 1-block area (called a hit reference block) equal in pattern to the present block. The y_b collation searcher 23 notifies the hit reference blocks to the y_b candidate value decider 24. The operation of the y_b collation searcher 23 responds to the result of the decision by the horizontal contour decider 21.

The y_b candidate value decider 24 labels the value at the pixel in each hit reference block which corresponds to the middle pixel y_b of interest in the related block of the to-be-enhanced image as a candidate value for the middle pixel y_b of interest. The y_b candidate value decider 24 notifies the candidate values for selected ones of the middle pixels to the y_b interpolation processor 25.

The y_b interpolation processor 25 expands the to-be-enhanced image into a 1-frame image in response to the middle-pixel values generated by the y_b bicubic interpolation value calculator 22 and the middle-pixel values generated by the y_b candidate value decider 24. Thereby, the y_b interpolation processor 25 generates every pair of a 1-frame left-eye image and a 1-frame right-eye image for 3D presentation as a result of decoding every 1-frame AB image represented by the input video signal. The y_b interpolation processor 25 synchronously outputs a video signal representative of the generated 1-frame left-eye image and a video signal representative of the generated 1-frame right-eye image.

Detailed operation of the apparatus 20 is as follows. The horizontal contour decider 21 decides whether or not a clear horizontal contour is present in each of portions of the to-be-enhanced image in every 1-frame AB image represented by the input video signal. As will be made clear later, each of these portions is a middle pixel y_b of interest between an actual pixel y[i, j] and an actual pixel y[i, j+1]. Specifically, the horizontal contour decider 21 evaluates the to-be-enhanced image, and decides a threshold value based on the result of the evaluation. The horizontal contour decider 21 calculates the absolute value of the difference between values at a pixel y[i, j] and a pixel y[i, j+1] neighboring in the vertical direction. The horizontal contour decider 21 compares the calculated absolute value with the threshold value to determine whether or not the calculated absolute value exceeds the threshold value. When the calculated absolute value exceeds the threshold value, the horizontal contour decider 21 decides that a clear horizontal contour is present in a corresponding portion of the to-be-enhanced image (at the middle pixel y_b of interest). Otherwise, the horizontal contour decider 21 decides that a clear horizontal contour is absent. The horizontal contour decider 21 notifies the result of this decision to the y_b bicubic interpolation value calculator 22 and the y_b collation searcher 23.

When the horizontal contour decider 21 decides that a clear horizontal contour is present at the middle pixel y_b of interest, the y_b bicubic interpolation value calculator 22 implements known bicubic interpolation with respect to the to-be-enhanced image to calculate a value for the middle pixel y_b of interest. The y_b bicubic interpolation value calculator 22 notifies the calculated value for the middle pixel y_b of interest to the y_b interpolation processor 25.

When the horizontal contour decider 21 decides that a clear horizontal contour is absent from the middle pixel y_b of interest, the y_b collation searcher 23 implements pattern matching as follows. The y_b collation searcher 23 defines, in the to-be-enhanced image, a block approximately centered at the middle pixel y_b of interest and having 6 pixels in the vertical direction and 6 pixels in the horizontal direction as shown in FIG. 6 where the small circle denoted by the arrow indicates the pixel y[i, j]. For the defined block in the to-be-enhanced image, the y_b collation searcher 23 implements pattern matching between the to-be-enhanced image and the reference image to search the reference image for a hit 1-block area (a hit reference block) equal in pattern to or matching in pattern with the defined block.

In more detail, for the block in the to-be-enhanced image, the y_b collation searcher 23 places 25 middle pixels (which are denoted by the small triangles in FIG. 12) between the 30 actual pixels denoted by the small circles in FIG. 12. Each of the 25 middle pixels is located at the center between two neighboring actual pixels arranged in a vertical direction. The y_b collation searcher 23 sets the value of each middle pixel to the average of the values of upper and lower pixels neighboring the middle pixel. The y_b collation searcher 23 defines a new block centered at the middle pixel y_b of interest and having 5 middle pixels in the vertical direction and 5 middle pixels in the horizontal direction. The y_b collation searcher 13 searches the reference image for a hit 1-block area (a hit reference block) equal in pattern to or matching in pattern with the new block at a 1-pixel pitch. This search detects a positional difference corresponding to a non-integral number (integer+0.5) of pixels in the vertical direction and an integral number of pixels in the horizontal direction.

The search by the y_b collation searcher 23 is to find a vector corresponding to best match. The values of 25 middle pixels for a new block are denoted by yh[i+s, j+t] where “s” indicates an integer varying from −2 to +2 and also “t” denotes an integer varying from −2 to +2. The value of a middle pixel centered at the new block is thus denoted by yh[i, j]. The values of the pixels in the reference image are denoted by g[i+s+p, j+t+q] where “p” indicates a variable in the range depending on the number of horizontally aligned pixels in the reference image, and “q” indicates a variable in the range depending on the number of vertically aligned pixels in the reference image. The pixel position coordinates for the reference image are regarded as being identical or exactly aligned with those for the to-be-enhanced image. Finding a vector corresponding to best match means finding a vector [p, q] which minimizes the summation S expressed by the previously-indicated equation (1). The pixel having the value g[i, j] in the equation (1) corresponds to the pixel y[i, j+(v/2)] when the to-be-enhanced image is the left-eye channel half (upper half) of the 1-frame AB image and the reference image is the right-eye channel half (lower half) thereof. The pixel having the value g[i, j] corresponds to the pixel y[i, j−(v/2)] when the to-be-enhanced image is the right-eye channel half of the 1-frame AB image and the reference image is the left-eye channel half thereof. Here, “v” denotes the interval between the vertically aligned pixels. The hit 1-block area (hit reference block) in the reference image is designated by the found vector [p, q]. The y_b collation searcher 23 notifies the hit reference block (the found vector [p, q]) to the y_b candidate value decider 24.

The horizontal-direction range of the search by the y_b collation searcher 23 is predetermined in accordance with the range of parallax in 1-frame AB images. The vertical-direction range of the search by the y_b collation searcher 23 is predetermined in accordance with the range of a positional error caused in taking pictures and caused by other factors. The parallax range and the positional error range can be decided by monitoring actual images.

The y_b candidate value decider 24 uses the value at the pixel in each hit reference block which corresponds to the middle pixel y_b of interest in the related block of the to-be-enhanced image as a candidate value for the middle pixel y_b of interest. The y_b candidate value decider 24 notifies the candidate value for the middle pixel y_b of interest to the y_b interpolation processor 25.

The y_b interpolation processor 25 labels the middle-pixel value generated by the y_b bicubic interpolation value calculator 22 or the middle-pixel value generated by the y_b candidate value decider 24 as a final value assigned to the middle pixel y_b of interest. The y_b interpolation processor 25 implements interpolation to place the middle pixel y_b of interest, which has been assigned the final value, equidistantly between the actual pixel y[i, j] and the actual pixel y[i, j+1] in the to-be-enhanced image as an interpolation-result pixel.

The to-be-enhanced image is scanned while the middle pixel y_b of interest is periodically replaced from one to another to complete all the middle pixels (interpolation-result pixels) added to the to-be-enhanced image. Thus, the y_b interpolation processor 25 expands the to-be-enhanced image into a 1-frame image in response to the middle-pixel values generated by the y_b bicubic interpolation value calculator 22 and the middle-pixel values generated by the y_b candidate value decider 24. Specifically, the y_b interpolation processor 25 labels the middle-pixel values generated by the y_b bicubic interpolation value calculator 22 and the middle-pixel values generated by the y_b candidate as final values assigned to the middle pixels. The y_b interpolation processor 25 implements interpolation to place the middle pixels, which have been assigned the final values, vertically between the actual pixels in the to-be-enhanced image to generate an expanded 1-frame image. Thereby, the y_b interpolation processor 25 generates every pair of a 1-frame left-eye image and a 1-frame right-eye image for 3D presentation as a result of decoding every 1-frame AB image represented by the input video signal. The generated 1-frame left-eye image is higher in definition (resolution) than the left-eye channel half of the 1-frame AB image. The generated 1-frame right-eye image is higher in definition (resolution) than the right-eye channel half of the 1-frame AB image. The y_b interpolation processor 25 synchronously outputs a video signal representative of the generated 1-frame left-eye image and a video signal representative of the generated 1-frame right-eye image.

The half-size left-eye image 3A and the half-size right-eye image 3B in FIG. 10 which constitute the 1-frame AB image are in a pair for 3D presentation so that they closely resemble each other in contents. Thus, in many cases, good correspondence or correlation between the to-be-enhanced image and the reference image is ensured. Furthermore, the range of the search for a hit reference block in the reference image can be relatively narrow. Accordingly, the apparatus 20 can solve the problems caused by interframe integration for acquiring a high-resolution image. The apparatus 20 can generate every 3D-presentation pair of a decoding-result 1-frame left-eye image and a decoding-result 1-frame right-eye image which are close in quality and resolution to the original 1-frame left-eye image and the original 1-frame right-eye image. In the apparatus 20, actual pixels in a reference image can be used for interpolation to expand a to-be-enhanced image into a 1-frame image. Thus, image sharpness can be prevented from being dropped by band limitation caused in the case of conventional pixel linear interpolation.

With reference to FIG. 14, the apparatus 20 may include a computer having a combination of an input/output port 92, a CPU 94, a ROM 96, and a RAM 98. In this case, the apparatus 20 or the computer operates in accordance with a control program (computer program) stored in the ROM 96 or the RAM 98. The control program is designed to implement the horizontal contour decider 21, the y_b bicubic interpolation value calculator 22, the y_b collation searcher 23, the y_b candidate value decider 24, and the y_b interpolation processor 25. The input/output port 92 receives the input video signal. The input/output port 92 synchronously outputs a video signal representative of a stream of decoding-result 1-frame left-eye images and a video signal representative of a stream of decoding-result 1-frame right-eye images.

FIG. 9 is a flowchart of a segment of the control program which is executed for each of the middle pixels in the to-be-enhanced image being either the upper or lower half of every 1-frame AB image represented by the input video signal.

As shown in FIG. 9, a first step S11 of the program segment decides whether or not a clear horizontal contour is present at a middle pixel y_b of interest vertically between an actual pixel y[i, j] and an actual pixel y[i, j+1] in the to-be-enhanced image. Specifically, the step S11 calculates the absolute value of the difference between values at the actual pixel y[i, j+1] and the actual pixel y[i, j]. The step S11 compares the calculated absolute value with a predetermined threshold value to determine whether or not the calculated absolute value exceeds the threshold value. When the calculated absolute value exceeds the threshold value, the step S11 decides that a clear horizontal contour is present at the middle pixel y_b of interest. In this case, the program advances from the step S11 to a step S12. When the calculated absolute value does not exceed the threshold value, the step 11 decides that a clear horizontal contour is absent. In this case, the program advances from the step S11 to a step S13. The step S11 corresponds to the horizontal contour decider 21.

The step S12 implements known bicubic interpolation with respect to the to-be-enhanced image to calculate a value for the middle pixel y_b of interest. After the step S12, the program advances to a step S15. The step S12 corresponds to the y_b bicubic interpolation value calculator 22.

The step S13 searches the reference image for a hit 1-block area (a hit reference block) equal in pattern to or matching in pattern with a block in the to-be-enhanced image which is centered at the middle pixel y_b of interest. The block has a prescribed number of neighboring middle pixels. After the step S13, the program advances to a step S14. The step S13 corresponds to the y_b collation searcher 23.

The step S14 uses the value at the pixel in the hit reference block which positionally corresponds to the middle pixel y_b of interest in the related block of the to-be-enhanced image as a candidate value for the middle pixel y_b of interest. After the step S14, the program advances to the step S15. The step S14 corresponds to the y_b candidate value decider 24.

The step S15 uses the middle-pixel value generated by the step S12 or the middle-pixel value generated by the step S14 as a final value assigned to the middle pixel y_b of interest. The step S15 implements interpolation to place the middle pixel y_b of interest, which has been assigned the final value, equidistantly between the actual pixel y[i, j] and the actual pixel [i, j+1] in the to-be-enhanced image as an interpolation-result pixel. After the step S15, the current execution cycle of the program segment ends. The step S15 corresponds to the y_b interpolation processor 15.

The control program may be read from a recording medium before being loaded into the computer in the apparatus 20. Alternatively, the control program may be downloaded into the computer in the apparatus 20 from a communication network through the use of a communication interface.

What is claimed is:

1. A method of processing a signal representative of a combination image having a pair of 3D-presentation images horizontally arranged and resulting from compressing original 3D-presentation images into half size, the method comprising the steps of:
setting one of the left-hand and right-hand haves of the combination image as a to-be-enhanced image and setting the other as a reference image;
forming a block in the to-be-enhanced image, the block having a prescribed number of pixels and extending at and around an interpolation object position in the to-be-enhanced image;
searching the reference image for a reference block matching in pattern with the formed block;
deciding a value at a pixel in the reference block which positionally corresponds to the interpolation object position in the to-be-enhanced image to be a candidate value for an interpolation-result pixel; and
placing the interpolation-result pixel having the candidate value at the interpolation object position in the to-be-enhanced image to change the to-be-enhanced image into a resolution-enhanced image.

2. A method as recited in claim 1, wherein the searching step comprises:
setting a center between two horizontally neighboring pixels in the formed block as the interpolation object position;
generating a search base pixel having a value equal to an average of values of the two horizontally neighboring pixels;
placing the search base pixel between the two horizontally neighboring pixels to generate a new block from the formed block; and
using the new block as the formed block in the searching.

3. A method of processing a signal representative of a combination image having a pair of 3D-presentation images vertically arranged and resulting from compressing original 3D-presentation images into half size, the method comprising the steps of:
setting one of the upper and lower haves of the combination image as a to-be-enhanced image and setting the other as a reference image;
forming a block in the to-be-enhanced image, the block having a prescribed number of pixels and extending at and around an interpolation object position in the to-be-enhanced image;
searching the reference image for a reference block matching in pattern with the formed block;
deciding a value at a pixel in the reference block which positionally corresponds to the interpolation object position in the to-be-enhanced image to be a candidate value for an interpolation-result pixel; and
placing the interpolation-result pixel having the candidate value at the interpolation object position in the to-be-enhanced image to change the to-be-enhanced image into a resolution-enhanced image.

4. A method as recited in claim 3, wherein the searching step comprises:
setting a center between two vertically neighboring pixels in the formed block as the interpolation object position;
generating a search base pixel having a value equal to an average of values of the two vertically neighboring pixels;
placing the search base pixel between the two vertically neighboring pixels to generate a new block from the formed block; and
using the new block as the formed block in the searching.

5. An apparatus for processing a signal representative of a combination image having a pair of 3D-presentation images horizontally arranged and resulting from compressing original 3D-presentation images into half size, the apparatus comprises:
a searcher setting one of the left-hand and right-hand haves of the combination image as a to-be-enhanced image and setting the other as a reference image, the searcher forming a block in the to-be-enhanced image, the block having a prescribed number of pixels and extending at and around an interpolation object position in the to-be-enhanced image, the searcher searching the reference image for a reference block matching in pattern with the formed block;
a candidate value decider deciding a value at a pixel in the reference block which positionally corresponds to the interpolation object position in the to-be-enhanced image to be a candidate value for an interpolation-result pixel; and
an interpolation processor placing the interpolation-result pixel having the candidate value at the interpolation object position in the to-be-enhanced image to change the to-be-enhanced image into a resolution-enhanced image.

6. An apparatus as recited in claim 5, wherein the searcher sets a center between two horizontally neighboring pixels in the formed block as the interpolation object position, and generates a search base pixel having a value equal to an average of values of the two horizontally neighboring pixels, and wherein the searcher places the search base pixel between the two horizontally neighboring pixels to generate a new block from the formed block, and uses the new block as the formed block in the searching.

7. An apparatus for processing a signal representative of a combination image having a pair of 3D-presentation images vertically arranged and resulting from compressing original 3D-presentation images into half size, the apparatus comprising:
a searcher setting one of the upper and lower haves of the combination image as a to-be-enhanced image and setting the other as a reference image, the searcher forming a block in the to-be-enhanced image, the block having a prescribed number of pixels and extending at and around an interpolation object position in the to-be-enhanced image, the searcher searching the reference image for a reference block matching in pattern with the formed block;
a candidate value decider deciding a value at a pixel in the reference block which positionally corresponds to the interpolation object position in the to-be-enhanced image to be a candidate value for an interpolation-result pixel;
an interpolation processor placing the interpolation-result pixel having the candidate value at the interpolation object position in the to-be-enhanced image to change the to-be-enhanced image into a resolution-enhanced image.

8. An apparatus as recited in claim 7, wherein the searcher sets a center between two vertically neighboring pixels in the formed block as the interpolation object position, and generates a search base pixel having a value equal to an average of values of the two vertically neighboring pixels, and wherein the searcher places the search base pixel between the two vertically neighboring pixels to generate a new block from the formed block, and uses the new block as the formed block in the searching.
